(19) United States
(12) Patent Application Publication
(10) Pub. No.: US 2003/0123212 A1
(43) Pub. Date: Jul. 3, 2003

(54) Control system for electrical switchgear

(76) Inventors: Michael P. Dunk, Caledonia, WI (US); John P. Jonas, Greendale, WI (US)

Correspondence Address: FISH & RICHARDSON P.C., 1425 K STREET, N.W., 11TH FLOOR, WASHINGTON, DC, 20005-3500, US

(21) Appl. No.: 10/067,530

(22) Filed: Feb. 7, 2002

Related U.S. Application Data
(60) Provisional application No. 60/343,594, filed on Jan. 2, 2002.

(51) Int. Cl. H01H 47/00

(52) U.S. Cl. 361/160

(57) ABSTRACT

A system for an AC electrical circuit includes an actuator, a source, and an actuator control system. The actuator converts current into a force to move contacts relative to one another to switch power on and off in the AC electrical circuit. The source operates to supply current to the actuator. The actuator control system is connected to the actuator and to the source to control the current to the actuator. The current to the actuator is independent of a voltage produced by the actuator during switching and a voltage at which the source operates

### TECHNICAL FIELD

This application relates to control of electrical switchgear.

### BACKGROUND

In a power distribution system, switchgear are typically employed to protect the system against abnormal conditions, such as power line fault conditions or irregular loading conditions. There are different types of switchgear for different applications. A fault interrupter is one type of switchgear. Fault interrupters are employed to automatically open a power line upon the detection of a fault condition.

Reclosers are another type of switchgear. In response to a fault condition, a recloser, unlike a fault interrupter, rapidly trips open and then recloses the power line a number of times in accordance with a set of time-current curves. Then, after a predetermined number of trip/reclose operations, the recloser will lock-out the power line if the fault condition has not been cleared.

A breaker is a third type of switchgear. Breakers are similar to reclosers. However, they are generally capable of performing only a single open-close-open sequence, and the currents at which they interrupt current flow are significantly higher than those of reclosers.

A capacitor switch is a fourth type of switchgear. Capacitor switches are used for energizing and de-energizing capacitor banks. Capacitor banks are used for regulating the line current feeding a large load (for example, an industrial load) when the load causes the line current to lag behind the line voltage. Upon activation, a capacitor bank pushes the line current back into phase with the line voltage, thereby boosting the power factor (that is, the amount of power being delivered to the load). Capacitor switches generally perform one open operation or one close operation at a time.

### SUMMARY

In one aspect, a system for an AC electrical circuit includes an actuator, a source, and an actuator control system. The actuator converts current into a force to move contacts relative to one another to switch power on and off in the AC electrical circuit. The source operates to supply current to the actuator. The actuator control system is connected to the actuator and to the source to control the current to the actuator. The current to the actuator is independent of a voltage produced by the actuator during switching and a voltage at which the source operates.

Embodiments may include one or more of the following features. For example, the system may also include an amplifier that controls the current from the source to the actuator. The system may further include a controller connected to the source and the amplifier and configured to sense voltage from the source, and provide information to the amplifier to control the current to the actuator.

The source may operate at a voltage that is greater than the voltage produced by the actuator during switching. The actuator may convert the current into the force to move the contacts in a linear direction relative to one another.

The actuator may switch power on and off in the AC electrical circuit by moving at least one of the contacts away from the other contact. The contacts may be connected to the AC electrical circuit such that when the contacts touch, current flows through the AC electrical circuit. The actuator control system may include a controller that senses the voltage provided by the voltage source.

The system may include control circuitry connected to the contacts such that control of the actuator current is based on information from the control circuitry.

In another general aspect, a method for controlling an actuator connected to an AC electrical circuit to interrupt current includes supplying power to an actuator and controlling current to the actuator such that the current to the actuator is independent of a voltage produced by the actuator during switching and a voltage at which the power is supplied. The actuator is configured to convert current into a force to move contacts relative to one another to switch power on and off in the AC electrical circuit.

In another general aspect, an actuator control system for an AC electrical circuit includes an actuator interface, an input interface, and a controller connected to the actuator interface and to the input interface. The actuator interface connects to an actuator that converts current into a force move contacts relative to one another to switch power on and off in the AC electrical circuit. The input interface connects to a source that operates to supply current to the actuator. The controller controls the current to the actuator such that the current to the actuator is independent of a voltage produced by the actuator during switching and a voltage at which the source operates.

The details of one or more embodiments are set forth in the accompanying drawings and the description below. Other features, objects, and advantages will be apparent from the description and drawings, and from the claims.

### DESCRIPTION OF DRAWINGS

FIG. 1 is a block diagram of a system including an actuator control system.

FIG. 2 is a block diagram of an input interface included in the actuator control system of FIG. 1.

FIGS. 3A-3I are diagrams of components of the input interface of FIG. 2.

FIG. 4A is a block diagram of a control interface included in the actuator control system of FIG. 1.

FIGS. 4B and 4C are diagrams of components of the control interface of FIG. 4A.

FIG. 5 is a diagram of a command interface included in the actuator control system of FIG. 1.

FIG. 6 is a diagram of a sensor interface included in the actuator control system of FIG.

FIG. 7A is a block diagram of an actuator interface included in the actuator control system of FIG. 1.

FIGS. 7B-7G are diagrams of components of the actuator interface of FIG. 7A.

FIGS. 8-14 are flow charts of procedures performed by the actuator control system of FIG. 1.

FIG. 15 is a graph of operating voltage of an energy storage section in the input interface versus time and a graph of current through the actuator versus time.

Like reference symbols in the various drawings indicate like elements.

### DETAILED DESCRIPTION

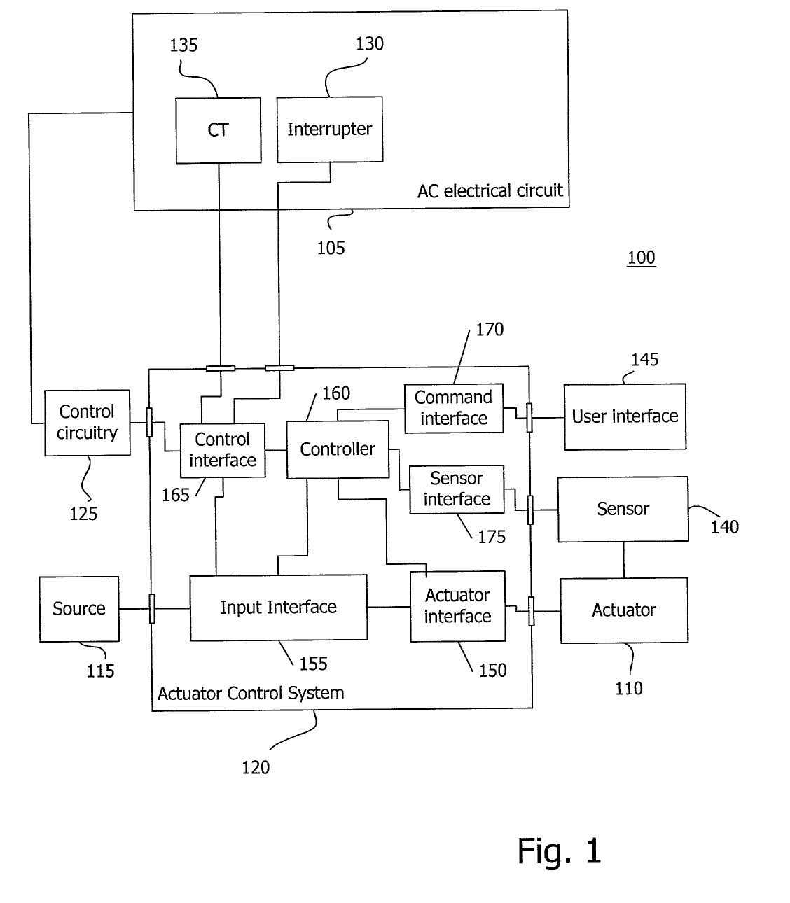

Referring to FIG. 1, a system 100 protects an AC electrical circuit 105 against abnormal conditions. The system 100 includes an actuator 110, a source 115, an actuator control system 120, and control circuitry 125. The actuator 110 converts current into a force to move contacts relative to one another to switch power on and off in the AC electrical circuit 105.

In particular, the actuator 110 converts the current into a force to move the contacts in a linear direction relative to each other. AC electrical circuit 105 includes an interrupter 130 that includes the contacts. The interrupter 130 is connected to the AC electrical circuit 105 such that the position of the contacts controls whether current flows through the circuit 105.

The source 115 operates to supply current to the actuator 110. The source 115 operates at a voltage that is greater than a voltage produced by the actuator 110 during switching of the interrupter 130. The actuator control system 120 is connected to the actuator 110 and to the source 115 to control the current supplied by the source 115 to the actuator 110.

The actuator control system 120 is also connected to a current transformer 135 associated with the circuit 105. The current transformer 135 senses conditions of the circuit 105 such as, for example, current and voltage. The actuator control system 120 is also connected to a sensor 140 associated with the actuator 110. The sensor 140 senses conditions of the actuator 110 such as, for example, position and speed. Additionally, the actuator control system 120 is connected to a host computer 145 that provides and receives information from a user.

The actuator control system 120 includes, among other elements, an actuator interface 150, an input interface 155, and a controller 160. The actuator interface 150 connects to the actuator 110. The input interface 155 connects to the source 115. The controller 160 is connected to the actuator interface 150 and to the input interface 155 to control the current to the actuator 110 based on information associated with the AC electrical circuit 105.

The actuator control system 120 also includes a control interface 165, a command interface 170, and a sensor interface 175. The control interface is connected to the control circuitry 125, to the current transformer 135, and to the interrupter 130. The command interface 170 is connected to the host computer 145. The sensor interface 175 is connected to the sensor 140.

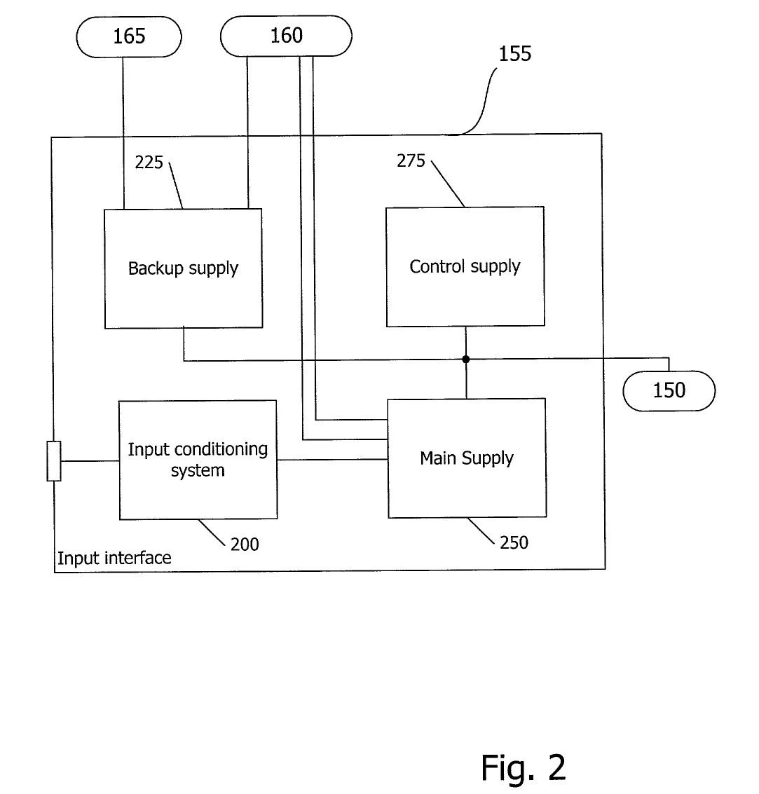

The input interface 155 is designed to reduce electrical noise coming out of and going to the actuator control system 120. The input interface 155 also provides some protection from high voltage frequency transients that could cause internal damage. Referring also to FIG. 2, the input interface 155 includes an input conditioning system 200 and one or more power supplies, such as a backup supply 225, a main supply 250, and a control supply 275.

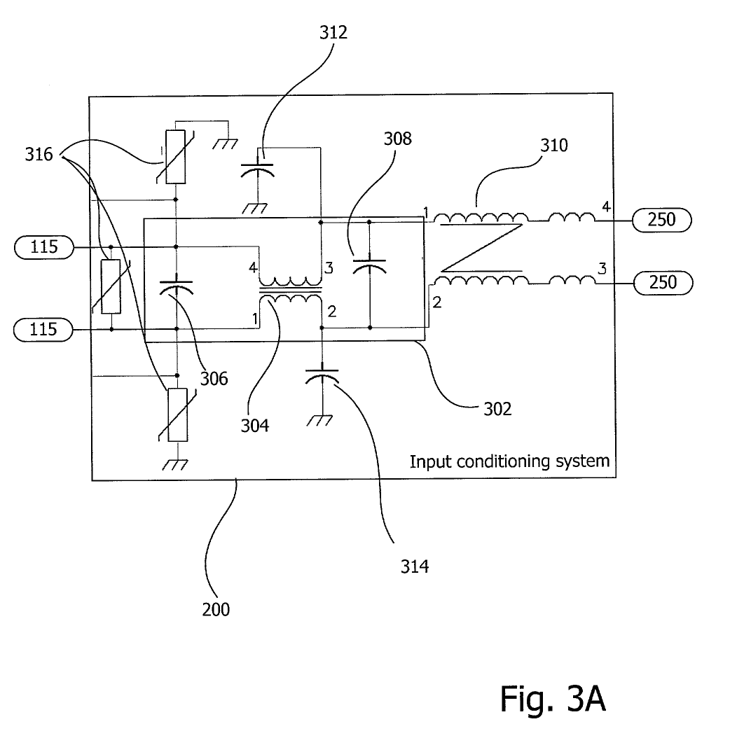

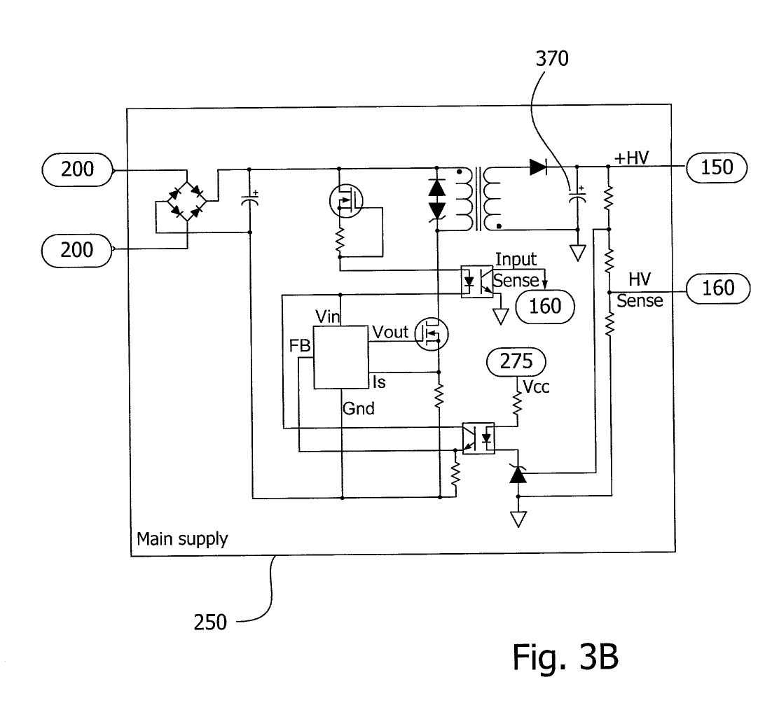

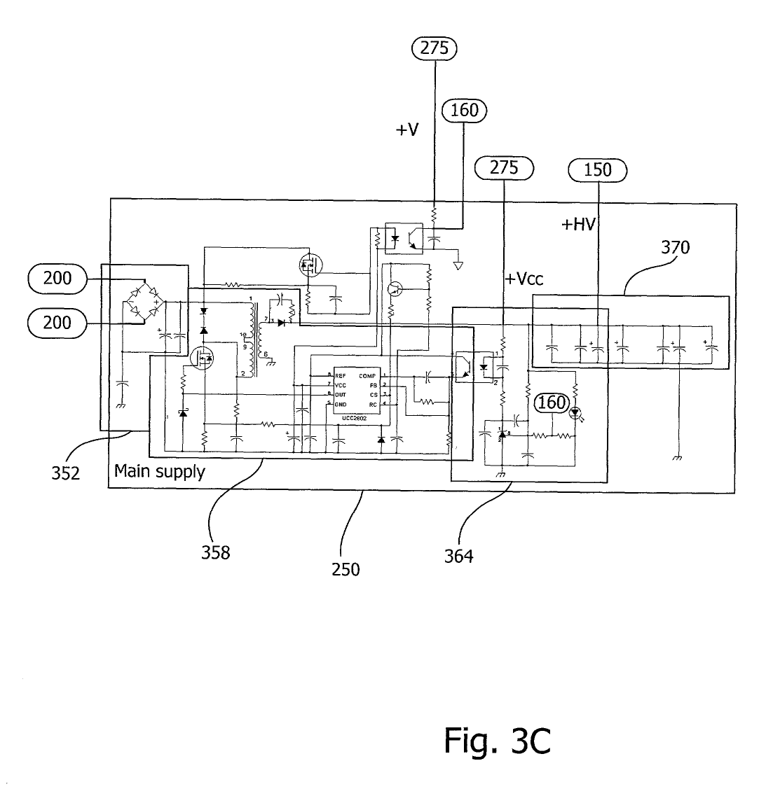

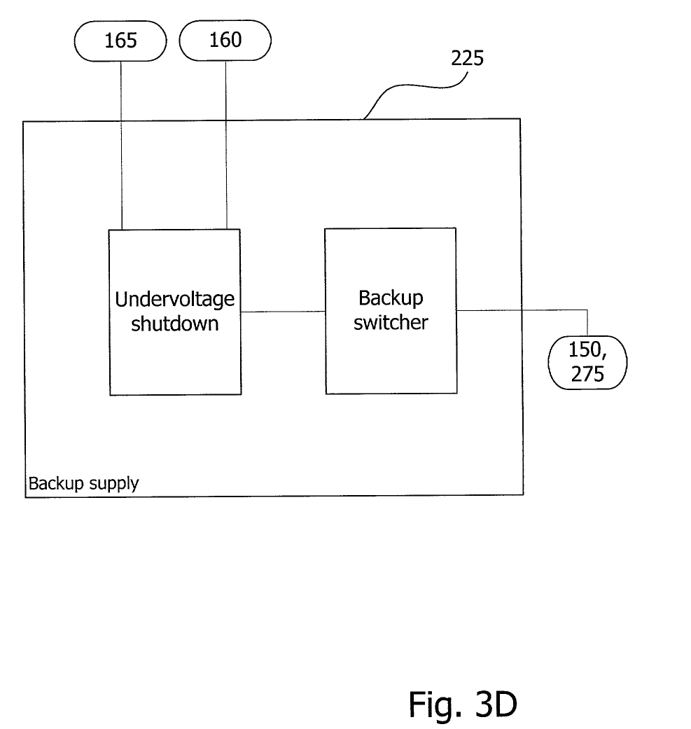

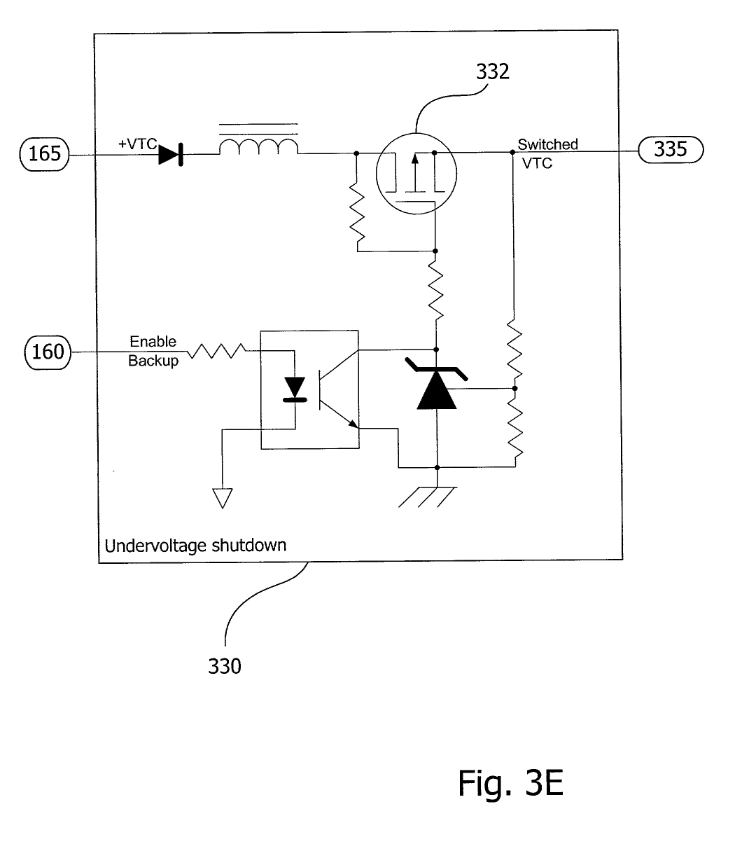

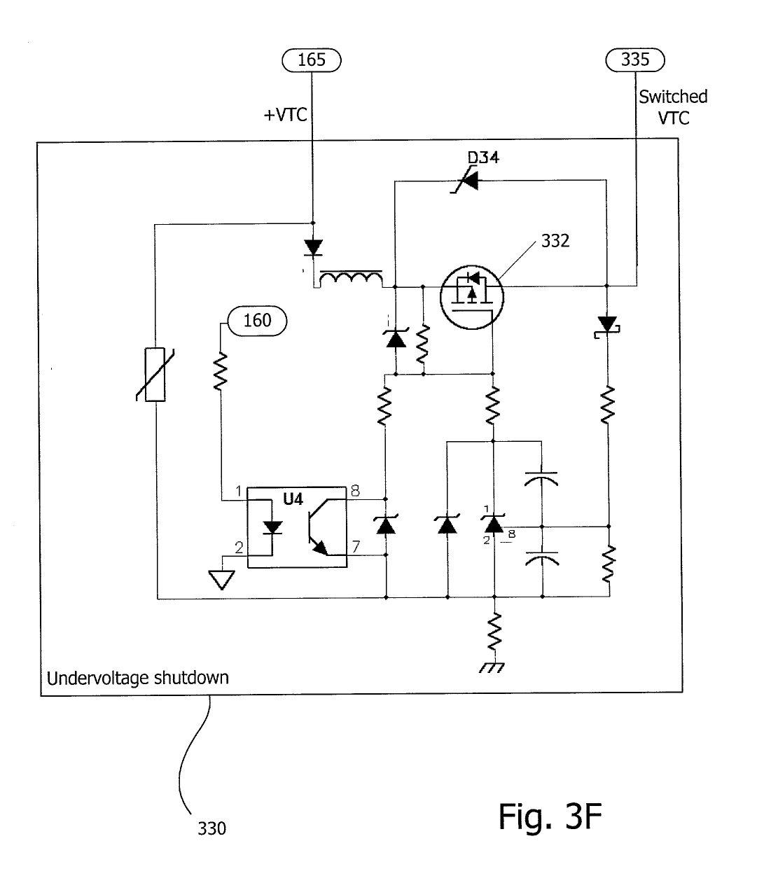

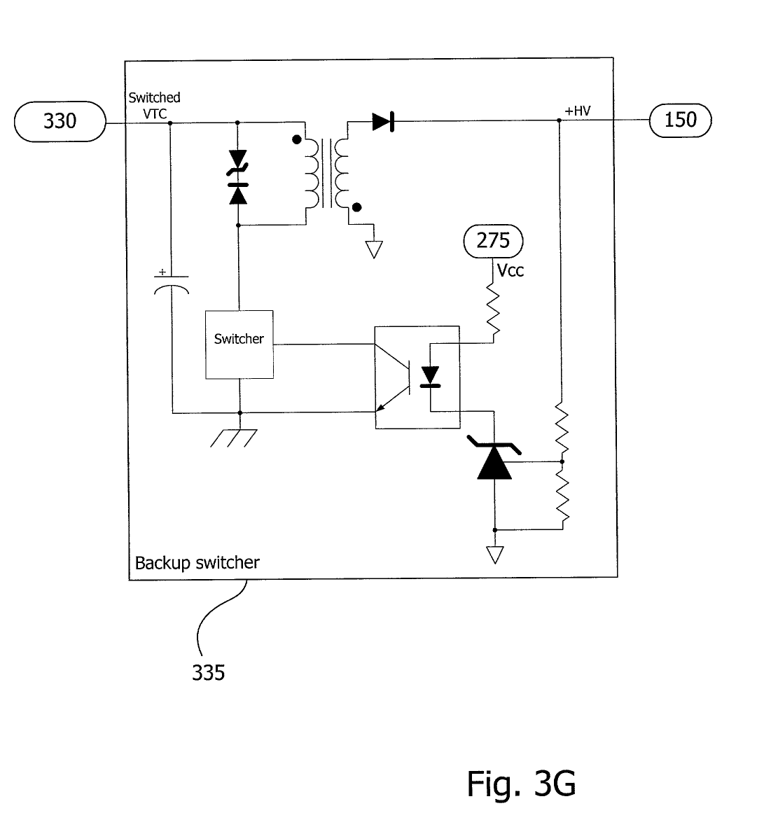

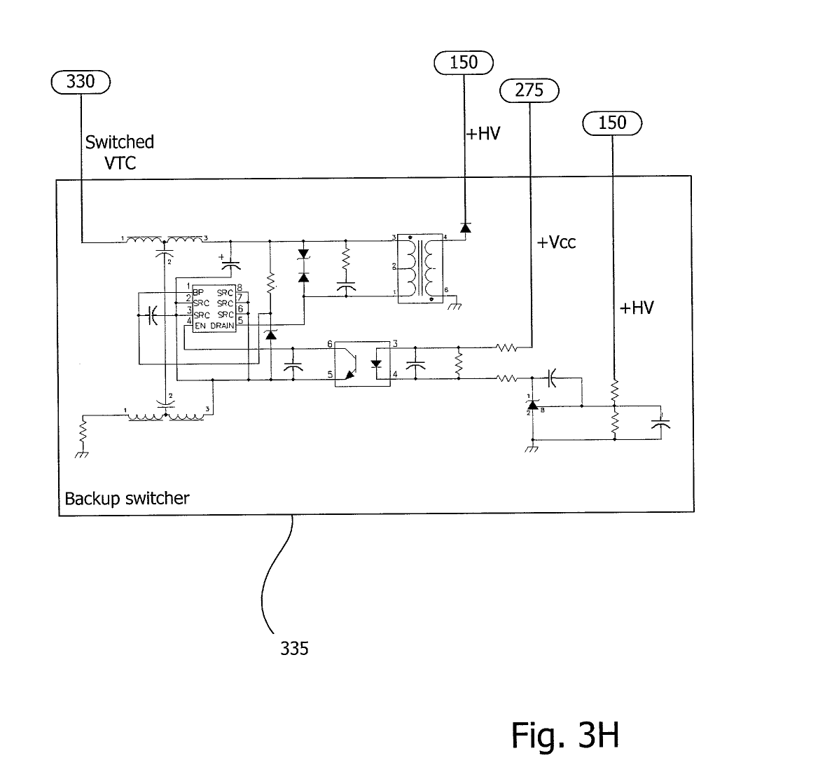

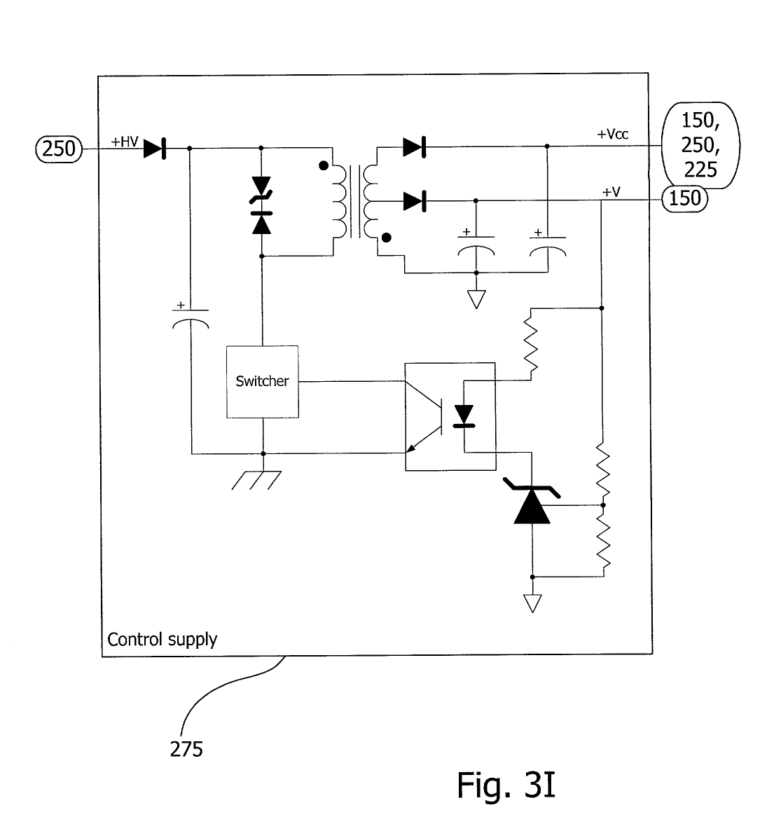

The input conditioning system 200 filters out noise generated by the source 115. Referring also to FIG. 3A, in one implementation, the input conditioning system 200 includes a low pass filter 302 that cuts off frequencies below a threshold determined by the filter's internal components of the filter. The low pass filter 302 includes a common mode choke 304 and capacitors 306, 308 that are configured with a cutoff frequency of 3 kHz. Optionally, a device 310, which may be a ferrite bead and common choke combination, provides additional attenuation of noise. The system 200 may also include a T-section low pass filter consisting of capacitors 312 and 314 that help improve the surge handling capacity of the power input from the source 115. The system 200 may also include high voltage ceramic devices 316, such as metal oxide varistors (MOVs), for protecting the source inputs from line-to-line overvoltages and for improving surge handling capacity.

The main supply 250 provides operational power to the actuator control system 120 by converting the input power from the source 115. The main supply 250 also serves to isolate the interrupter 130 from the source 115.

Referring to FIG. 3B, in one implementation, the main supply 250 may be designed as a fully-isolated current-mode flyback switcher. The input range of the main supply 250 may be lower or higher than the output of the main supply 250. The main supply 250 is designed to operate at 1-3 Watts continuously with very infrequent bursts to full power. The main supply 250 electrically isolates the interrupter 130 from the source 115.

FIG. 3C shows a circuit diagram of the main supply 250 of FIG. 3B. The main supply 250 includes an input section 352, a switching section 358, a feedback section 364, and an energy storage section 370.

The input section 352 rectifies the incoming power when the incoming power is AC. If the incoming power is DC, then the input section 352 directs the power so that the input is non-polarized. The input section 352 includes an input bridge 353 and a bridge rectifier 354. Additionally, the input section 352 includes a filter 355 that keeps the voltage of the switching section 358 from going below a predetermined threshold to avoid dropouts during charge up conditions. Assuming a 105 V input with an input current of 1 A at 60 HZ, the peak voltage is 105×1.414=148V.

The switching section 358 generates the main supply power. In one implementation, the switching section 358 includes a pulse-width-modulated (PWM) controller. The PWM controller may be implemented in a UCC2802 available from Unitrode. The UCC2802 is a high-speed, low-power integrated circuit having peak current mode or average current control and using a dual loop control circuit to adjust the regulating pulse width in response to load changes.

The feedback section 364 closes the regulation loop of the main supply 250. The feedback section 364 senses +HV from the backup supply 225, divides this signal through a set of resistors, and then filters the signal with a capacitor.

The energy storage section 370 is a set of parallel capacitors. For operation in the extreme cold, the section 370 has a total capacitance of 8800 μF. Because the output of the main supply 250 is well regulated, the capacitors may be operated at their rated voltage.

Referring to FIG. 3D, in one implementation, the backup supply 225 includes an undervoltage shutdown 330 connected to the controller 160 and to the control interface 165, and a backup switcher 335 connected to the actuator interface 150.

The undervoltage shutdown 330 senses the voltage level from the control interface 165 and disconnects the backup supply 225 when the voltage level drops below a predetermined threshold level. Thus, the undervoltage shutdown 330 prevents the backup supply 225 from overdischarging the backup switcher 335 below a predetermined threshold. Moreover, the undervoltage shutdown 330 prevents the backup switcher 335 from turning off before the voltage from the control interface 165 turns off. Referring to FIG. 3E, in one implementation, the undervoltage shutdown 330 is designed with a switch 332. FIG. 3F shows a more detailed circuit for the undervoltage shutdown 330.

The backup switcher 335 maintains a voltage supply capable of operating the interrupter 130 through the actuator 110 if the main supply 250 is not operating. The backup switcher 335 derives its power from the control interface 165. Referring also to FIG. 3G, in one implementation, the backup switcher 335 operates as an isolated, step-up, flyback power supply. The backup switcher 335 is configured to be capable of supplying all the power necessary to operate the actuator control system 120 and to complete at least one open/close operation through the interrupter 130. FIG. 3H shows a more detailed circuit of the backup switcher 335.

The control supply 275 generates additional power as required by the actuator interface 150. The control supply 275 is designed to operate from the storage capacitors 352 of the main supply 250 and to receive input voltage from the backup supply 225. Referring also to FIG. 31, one implementation of the control supply 275 is a simple, isolated, step-down, switching power supply having two outputs, +V (which is +5V in this implementation) and +Vcc (which is +15V in this implementation).

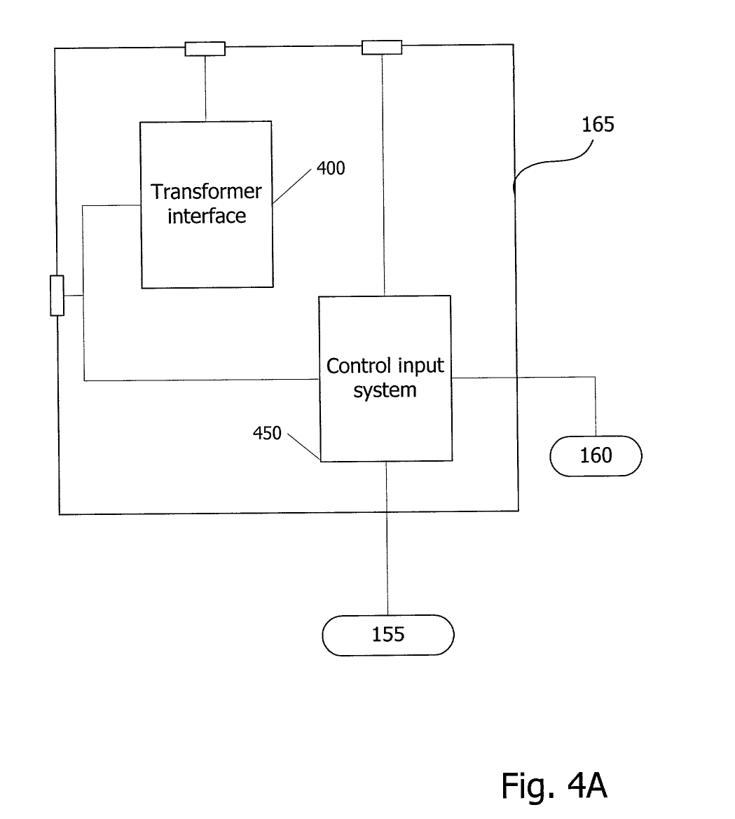

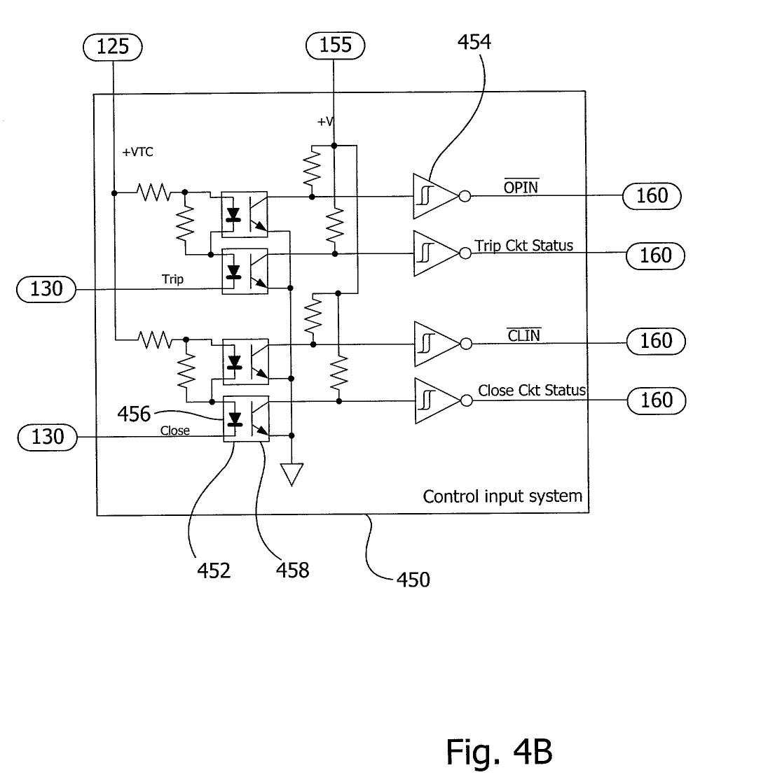

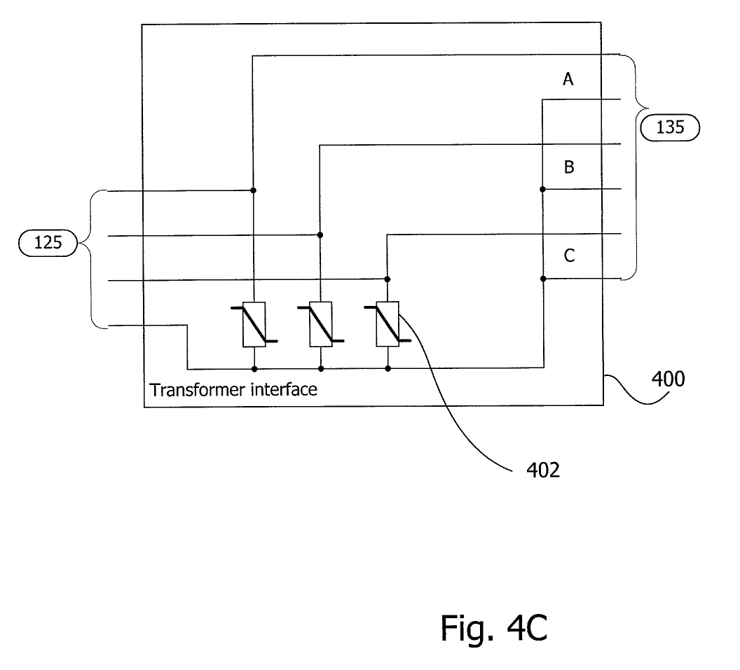

The control interface 165 senses interrupt signals from the control circuitry 125 and converts them to logic signals for the controller 160. As shown in FIG. 4A, to perform these functions, the control interface 165 includes a transformer interface 400 and a control input system 450. The control input system 450 isolates and detects interrupt signals from the control circuitry 125. Additionally, the control input system 450 routes the interrupt signals through the interrupter 130. The transformer interface 400 terminates and routes leads to the current transformer 135 and provides protection from special conditions of the current transformer 135.

Referring to FIG. 4B, the control input system 450 may include one or more optocouplers 452 and one or more Schmitt inverters 454, with each Schmitt inverter 454 being associated with an optocoupler 452. Each optocoupler 452 includes a light emitting diode (LED) 456 and a transistor 458. The optocouplers 452 provide isolation between the control circuitry 125 and the internal circuitry referenced to ground. Current flows through the LED 456 when the trip or close signal is pulled low, thus turning on the optocoupler 452 and pulling the corresponding transistor collector low. Output from the transistor 458 is buffered and inverted by the corresponding Schmitt inverter 454 and the resulting signal is sent to the controller 160. The LED 456 will not conduct current until voltage across it reaches the forward voltage of the diode. Leakage currents through the LED 456 below this level do not create photons. To set a turn on level, the LED 456 is bypassed by a resistor having a value that creates a drop equal to the forward voltage at the specified current level. When the current reaches a predetermined value (for example, 10 mA), the voltage across the resistor exceeds the LED forward voltage (for example, 0.8-1.35 V depending on operating temperature). Current can then flow through the LED 456. Moreover, a resistor in series with the LED 456 sets the maximum voltage and the series resistor resistance is determined by the maximum current of the LED 456 and the power rating of the series resistor.

In another implementation, the control input system 450 may include another optocoupler in series with the first, but without a level-setting resistor. This second optocoupler may be used to detect a status current of the trip and close signals from the control circuitry 125. The controller 160 may use this information to determine the status of the interrupter 130 and to detect a control shutdown.

Referring also to FIG. 4C, the transformer interface 400 protects the current transformers on each phase (represented by A, B, and C for a tri-phase system) from damage if they are disconnected from the control circuitry 125. If current is surging through a current transformer while it is disconnected from the control circuitry 125 then the output voltage of the current transformer would rise to a point where insulation of the transformer is damaged. Thus, a surge protection device 402 are inserted into the high side of each transformer. Each of the surge protection devices may be implemented as a SIDACtor®, a device available by Teccor Electronics, Inc. Each SIDACtor 402 is in an off state until the voltage across the SIDACtor reaches a predetermined threshold, at which point the SIDACtor turns on and shorts the lines until current going through the SIDACtor is interrupted or drops below a minimum threshold. When the current going through the SIDACtor drops below the minimum threshold, the SIDACtor turns off until the voltage again rises above the predetermined threshold.

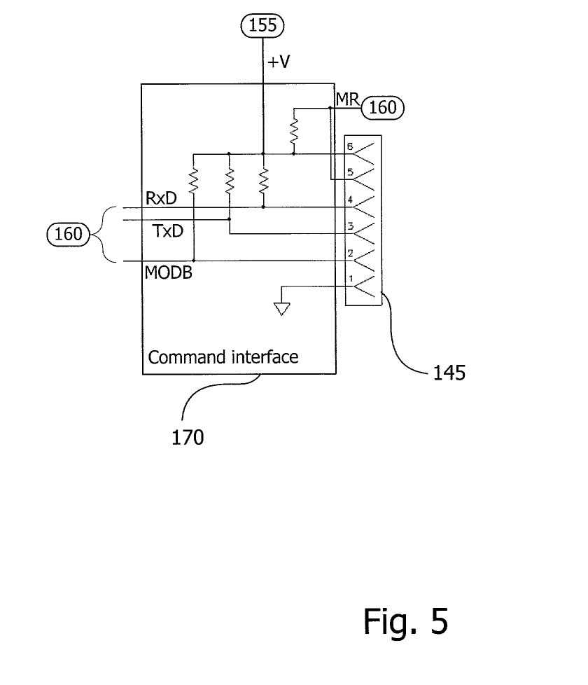

The command interface 170 provides a way for the user to program, test, and use the actuator control system 120. The command interface 170 is a logic level, asynchronous serial interface that also provides control to permit the user to place the system 120 into a program mode and reset the system 120. Referring to FIG. 5, the command interface 170 may be designed to connect with six pins of the host computer 145, each of which performs a different function. For example, pin 1 may set a target ground, pin 2 may force the controller 160 into bootstrap mode after reset, pin 3 may set serial data received by the controller 160 from an external host, pin 4 may set serial data sent from the controller 160 to the external host, pin 5 may reset the controller 160, and pin 6 may provide a test for the control supply 275.

The sensor interface 175 permits the controller 160 to sense information about the actuator 110. As discussed, the actuator 110 uses a linear force to switch power on and off in the AC electrical circuit 105. To do this, the actuator usually includes a device that moves along a linear direction to open or close the interrupter 130. Thus, information about the actuator 110 includes position and velocity information about the actuator's linear device. The information about the actuator 110 is used by the controller 160 to better control movement of the actuator's linear device.

For example, the actuator may be a magnetic actuator that includes a gapped magnetic field formed from a magnetic structure and a coil winding. The magnetic actuator operates in response to current flowing through the coil winding. This current reacts with the steady-state magnetic field in the gap of the magnetic structure to exert a force on the coil winding. The force exerted on the coil winding is transferred to an operating rod (the linear device), which is attached to the coil winding. The resulting force on the operating rod is proportional to current flowing through the coil winding and causes the operating rod to move along its linear axis to develop a force associated with an opening operation or a closing operation. The operating rod moves, either backward or forward, depending on the direction of current flow through the coil winding. The movement of the operating rod, in turn, causes a pair of contacts located in the interrupter 130 to either come together or pull apart, depending on whether the switching operation is an opening operation or a closing operation. Generally, the operating rod is held in an open or closed position with a latching device. The latching device provides enough contact pressure to minimize contact resistance and to hold the contacts together during rated, momentary currents. In various implementations, the latching device includes a canted spring, a ball plunger, a magnetic-type latch, a bi-stable spring, or a spring over-toggle.

Thus, the controller 160 may use the information to better control current through the coil winding. Additionally, the controller 160 can operate the actuator 110 to compensate for changing conditions due to manufacturing tolerances and environmental conditions. Such a sensor interface 175 also eliminates a need for a mechanical damping system (such as a dashpot), thus making the actuator 110 operate more efficiently.

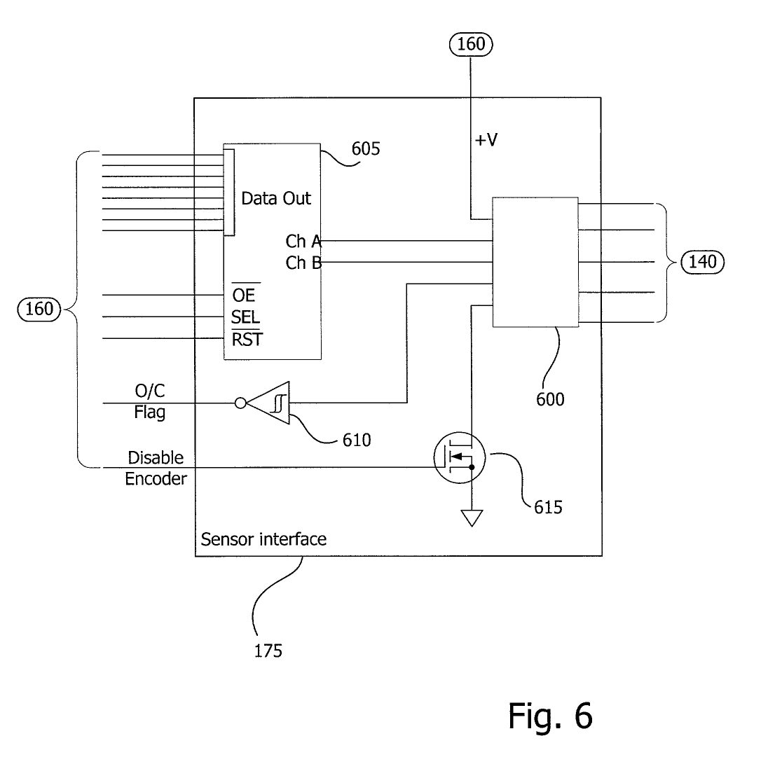

In one implementation, the sensor 140 is an optical incremental encoder. In this implementation, as shown in FIG. 6, the sensor interface 175 includes an encoder connector 600, a decoder 605 connected to the encoder connector 600, a Schmitt inverter 610, and a switch 615 such as a MOSFET. The optical incremental encoder produces two channels of square waves, A and B, with each channel being offset 90 degrees from the other. In operation, the encoder produces a square wave cycle each time an inscribed line on an encoder strip passes through the encoder. Each cycle represents a position change. If the cycle has a rate of 300 lines per inch, then the position change of the actuator 110 is 0.0033 inches. The decoder 605 counts each transition of the channels and gives an effective resolution of 1200 lines per inch or 0.000833 inches. The decoder 605 determines whether the position change is forward or backward based on whether channel A rises or falls before channel B. Additionally, because the controller 160 reads the position from the sensor 140 at fixed time intervals, the velocity of the actuator 110 may be determined.

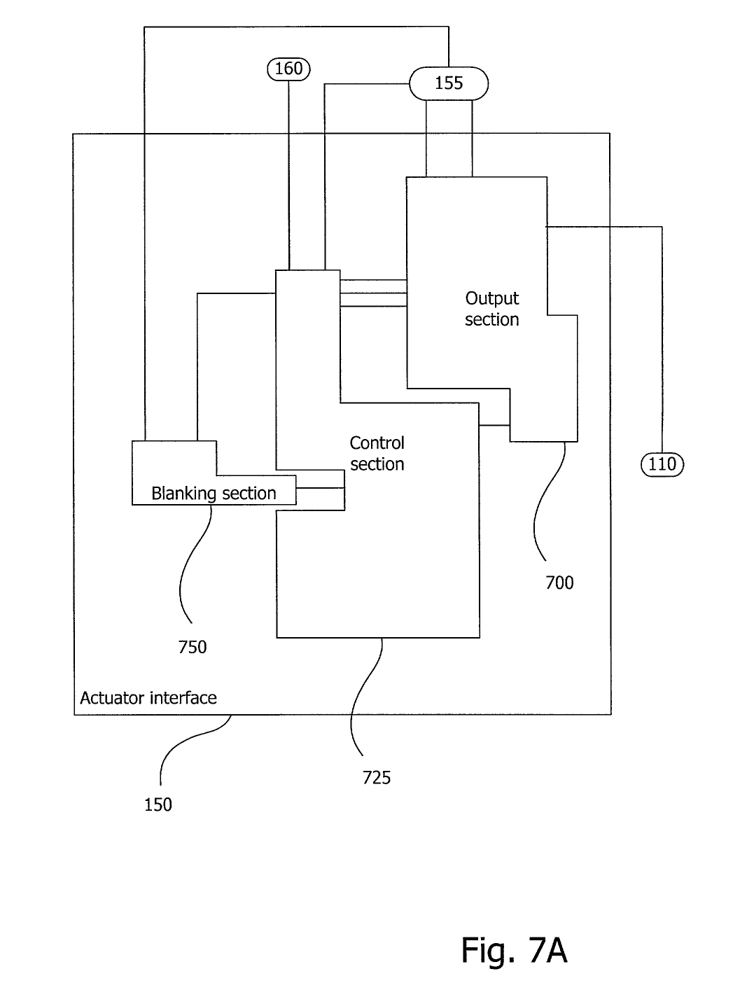

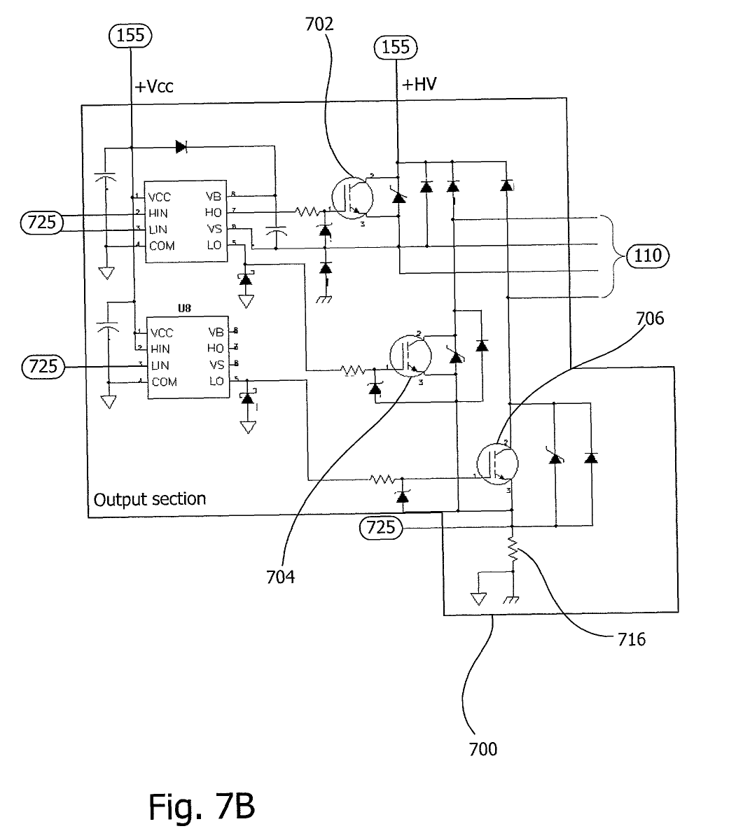

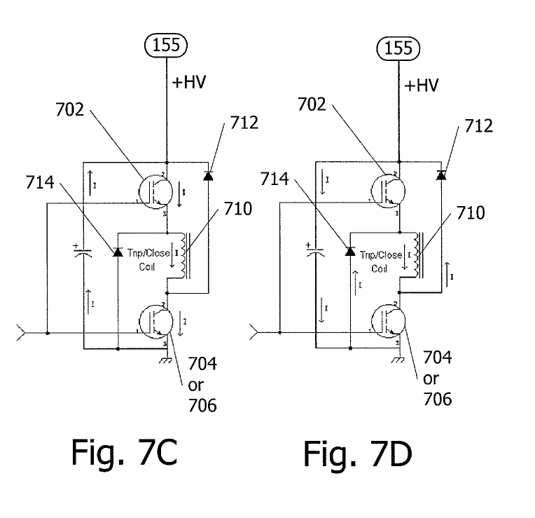

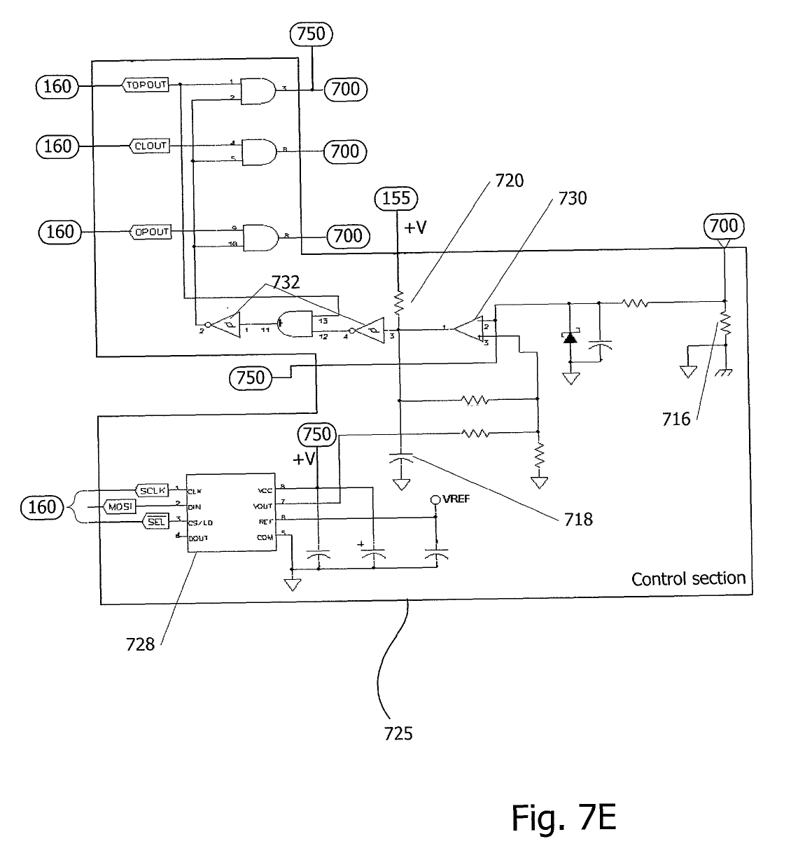

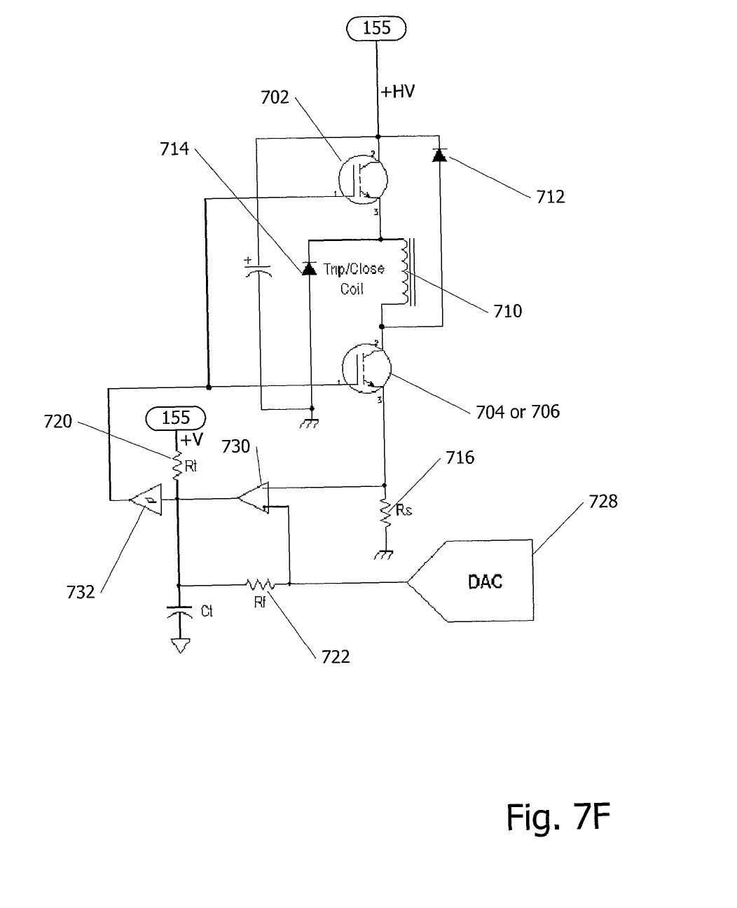

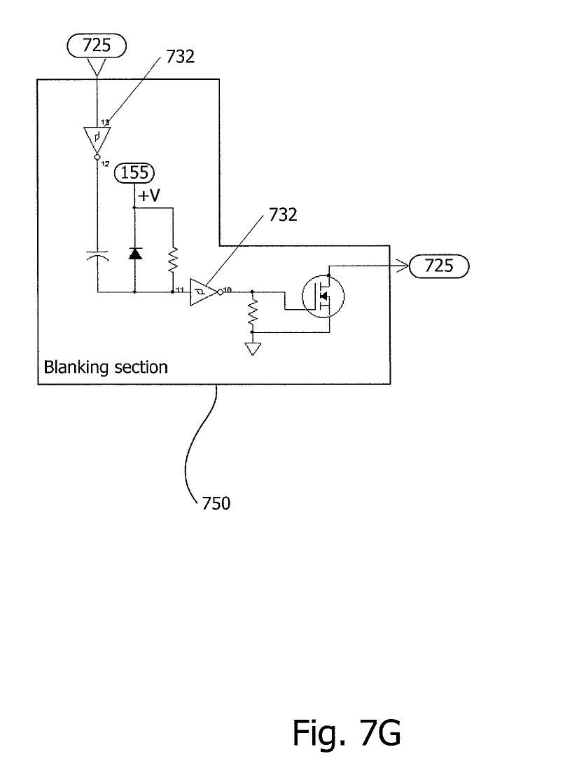

The actuator interface 150 receives digital input from the controller 160 and uses the digital input to control flow of current to the actuator 110. Referring to FIG. 7A, the actuator interface 150 includes an output section 700 and a control section 725. The output section 700 controls the currents through the actuator 110 and the control section 725 sets and maintains the commanded currents. The actuator interface 150 may also include a blanking section 750 that prevents transient noise from disturbing the output currents.

Referring also to FIG. 7B, in one implementation, the output section 700 is configured as a two-switch converter or a dual-forward converter. The output section 700 may include switches 702, 704, 706 and related resistors and diodes, with switches 704 and 706 being the low-side switches and sharing a high-side switch 702. In this implementation, as shown in FIGS. 7C and 7D, the output section 700 is configured to operate the coil 710 in a magnetic actuator. The coil 710 in the actuator is placed between the high-side switch 702 and a low-side switch 704 or 706. Both switches are turned on and off together. This configuration prevents high-voltage transients and increases efficiency of the actuator interface 150. When the switches 702 and 704 or 706 are turned on (FIG. 7C), current from the storage capacitor in the main supply 250 (input interface 155) begins to flow through the coil 710 of the actuator. The upper and lower diodes 712, 714, which are respectively associated with the switches 702, 704 or 706 are reversed biased and blocking. Since the coil 710 of the actuator can be considered a large inductor, the current will ramp up until the switches are turned back off. At this time, the energy stored in the actuator coil 710 causes current to continue to flow through the actuator coil 710 (FIG. 7D). The upper and lower diodes 712, 714, respectively become forward biased and begin to conduct. The energy stored in the coil 710 is returned to the storage capacitor in the main supply 250 minus some small losses.

Referring also to FIG. 7E, the control section 725 is basically a fixed off-time pulse width modulator. The control section 725 includes a digital-to-analog (D/A) converter 728 that receives a digital current command from the controller 160. As shown in the diagram of the control section 725 in FIG. 7F, the D/A converter 728 converts this command into a voltage level and outputs the voltage level to the +input of comparator 730. The output of the comparator 730 connects to the collector of the switch 702, 704, 706 and the timing capacitor is permitted to charge up to +V. A Schmitt inverter 732 turns on at +V, which then turns on the upper and lower switches 702, 704 or 706. Current begins to flow through the coil 710 and the sense resistor Rs 716. The current continues to ramp until the voltage drop across the resistor 716 rises above the output of the D/A converter 728. At this point, the output of the comparator 730 is pulled to ground and a timing capacitor Ct 718 is discharged. The output of the Schmitt inverter 732 goes to 0 V and the switches 702 and 704 or 706 are switched off. Current in the coil 710 begins to decline. The current in the sense resistor Rs 716 goes to zero and the comparator 730 switches back on. However, the capacitance of timing capacitor Ct 718 remains low and charges back up through resistor Rt 720 thus delaying the turn on of the switches 702 and 704 or 706 for some fixed time. After the off time is complete, the timing capacitor Ct 718 charges back to the turn on threshold and the cycle repeats. The resistor Rf 722 is used to prevent oscillations as the sense voltage approaches the reference voltage.

Referring also to FIG. 7G, the blanking section 750 may be used to inhibit the turn off of the pulse width modulator or control section 725 for some period of time after the switches 702 and 704 or 706 turn on. This permits any spike in current to pass without affecting the control section 725. Turning on the upper switch 702 triggers a monostable circuit that clamps the current sense signal to ground. After the monostable circuit times out, the clamp is released and the control section 725 operates as usual.

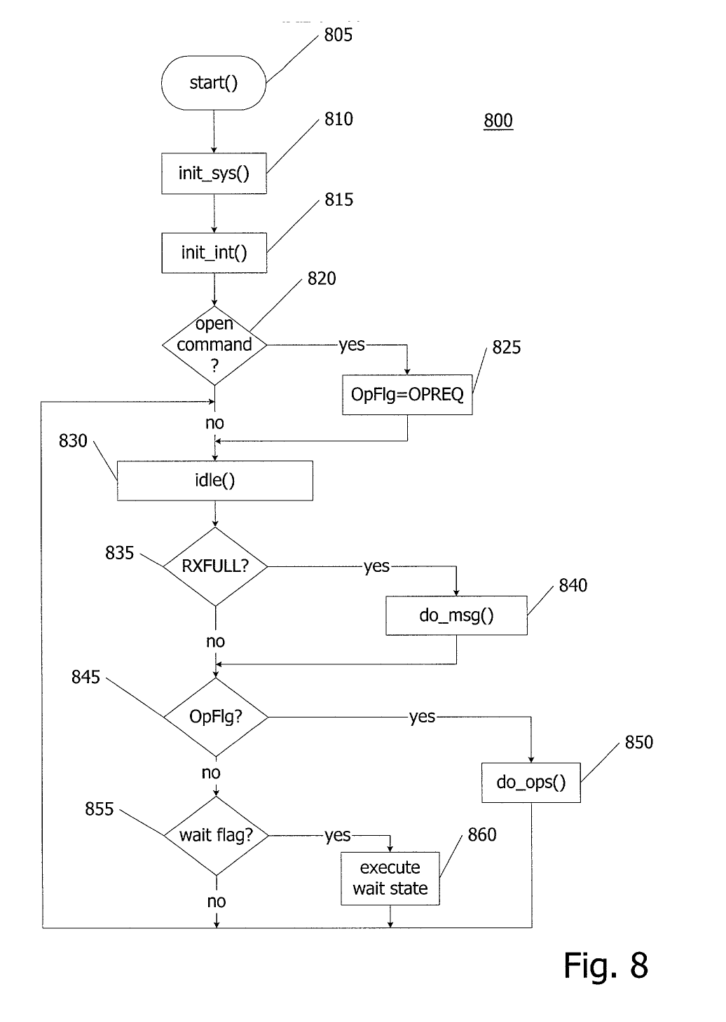

In operation, the actuator control system 120, through the controller 160, responds to open and close inputs from the control circuitry 125 to generate an appropriate current profile that is output to the actuator 110 to open or close the interrupter 130. Referring to FIG. 8, the actuator control system 120 performs a procedure 800 for generating appropriate current profiles. The actuator control system 120 initializes hardware through a start( ) procedure (step 805) and initializes program variables and completes final hardware set up through an init_sys( ) procedure (step 810).

The actuator control system 120 then enables interrupts that are active through an init_int( ) procedure (step 815). After the interrupts have been enabled, the system 120 checks for a pending open command that may have occurred before the interrupts were enabled (step 820). If the system 120 detects a pending open command (step 820), the system 120 sets up to execute the open command by setting a flag (OpFlg) (step 825).

If the system 120 does not detect a pending trip command (step 825), then the system 120 enters an idle state that begins with setting the actuator interface 150 to an off state and writing an internal register in the controller 160 (step 830). In this way, if the controller 160 stops operating, then the system 120 is able to reset itself.

Next, the system 120 checks for a command from the host computer 145 (indicated by the flag RXFULL) (step 835). A command from the host computer 145 is referred to as a serial command. If the system detects a serial command, then the system interprets the serial command and operates based on the serial command interpretation through a do_msg( ) procedure (step 840).

If the system does not detect a serial command, then the system checks for an open or close operation command (OpFlg) (step 845). If the system detects an operation command, then the system executes the open or close operation through a do_ops( ) procedure (step 850).

If it does not detect an operation command, then the system 120 checks for a wait command to determine if it should enter a low power state (step 855). If a wait command is detected, then the system 120 enters a low power state (step 860) and then transitions to the idle state. If a wait command is not detected, then the system 120 repeats the idle state without entering the low power state.

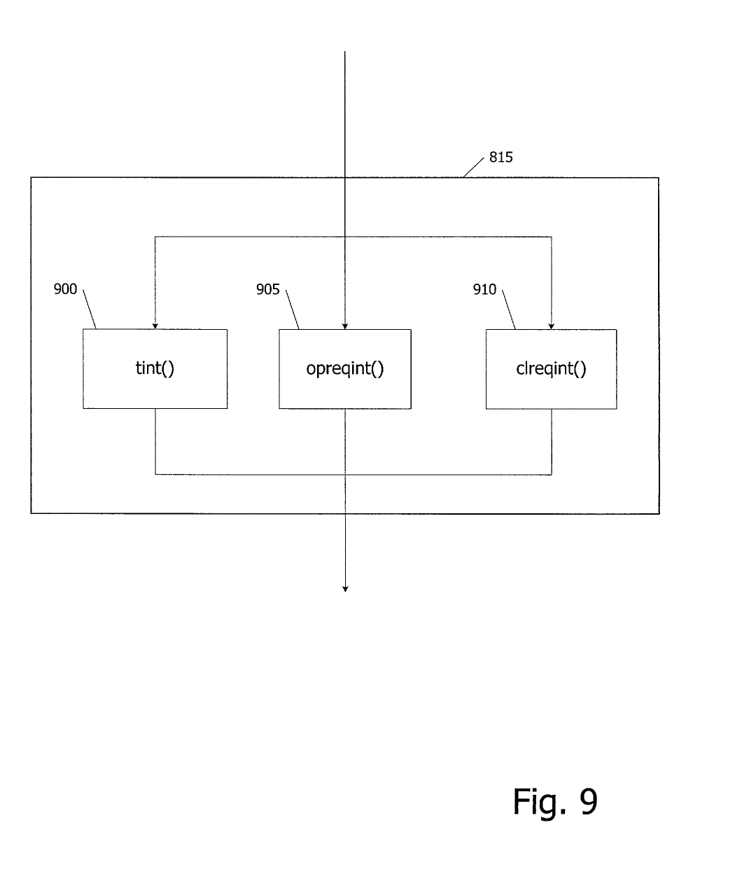

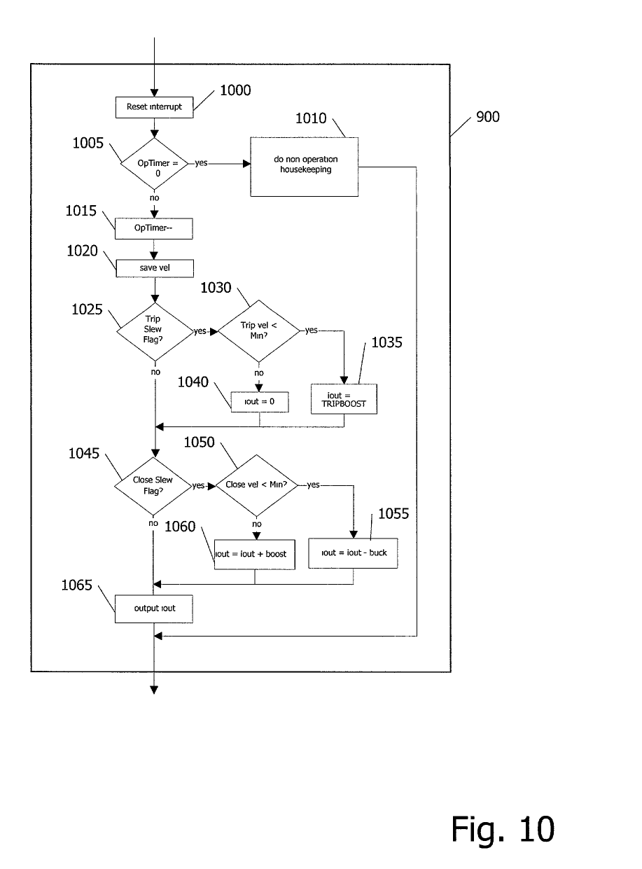

Referring also to FIG. 9, the actuator control system 120 may enable a timed interrupt (called tint( )) (step 900) when enabling interrupts that are active (step 815). The actuator control system 120 also may enable an open request interrupt (called opreqint( )) (step 905) when enabling interrupts that are active (step 815). As a further alternative, the actuator control system 120 may enable a close request interrupt (called clreqint( )) (step 910) when enabling interrupts that are active (step 815).

Referring to FIG. 10, the actuator control system 120 performs a procedure 900 when the timed interrupt is enabled. Initially, the system 120 resets the next interrupt and reads data from the sensor 140 (step 1000). Then, the system 120 determines if an operation is occurring (step 1005) by checking the state of an operation timer (called OpTimer).

If the system 120 determines that no operation is occurring (step 1005), then the system 120 performs a non-operation routine, referred to as a housekeeping routine (step 1010). During the housekeeping routine (step 1010), the system 120 may, for example, check the voltage of the energy storage section 370, check the status of the main supply 250, and set interlocks and an operational mode that may be entered during an open and close operation.

If the system 120 determines that an operation is occurring (step 1005), then the system 120 decrements the operation timer (step 1015) and records the present velocity of the actuator 110 in an array called IdArray (step 1020).

The system 120 determines if the operation is an open slew sequence (step 1025). An open slew sequence prevents the actuator 110 from slowing down too much during an open sequence. If the velocity drops below a predetermined threshold (called MINTRIPVEL) (step 1030), then the system 120 sets a temporary current (iout) to a fixed boost current (called TRIPBOOST) to ensure that the open operation completes (step 1035). Otherwise, the system 120 sets the temporary current (iout) to a zero current (step 1040).

The system 120 then determines if the operation is a close slew sequence (step 1045). A close slew sequence is the phase of a close sequence in which the actuator velocity is being controlled. If the operation is a close slew sequence, then the system 120 compares the present velocity to a target velocity (referred to as SETVEL) (step 1050). If the present velocity is greater than the target velocity, the system 120 subtracts a buck current from the temporary current and ensures that the current does not drop below zero (step 1055). If the present velocity is lower than the target velocity, the system 120 adds a boost current to the temporary current to increase the actuator velocity (step 1060). The system 120 then outputs the current to the actuator 110 based on the temporary current (step 1065).

The open request interrupt is generated when the system 120 detects an open request from the control circuitry 125. If the open request interrupt is enabled at step 815, then the system 120 turns on the sensor 140 in preparation for an open operation, waits for a period of time, and then determines if the open request is still present. If the open request is still present, the system 120 counts the open request and repeats the cycle of waiting and determining for a preset number of times (for example, five). If, after the preset number of times, the system 120 has counted more than a predetermined number of open requests, then the system 120 generates an open command and disables all of the interrupts. If, after the preset number of times, the system 120 has counted the predetermined number of open requests or fewer, then the system 120 does not generate an open command and resets the timed interrupt.

The closed request interrupt is generated when the system 120 detects a close request from the control circuitry 125. If the close request interrupt is enabled at step 815, then the system 120 turns on the sensor 140 in preparation for a close operation, waits for a period of time, and then determines if the close request is still present. If the close request is still present, the system 120 counts the close request and repeats the cycle of waiting and determining for a preset number of times (for example, five). If, after the preset number of times, the system 120 has counted more than a predetermined number of close requests, then the system 120 generates a close command and disables all of the interrupts. If, after the preset number of times, the system 120 has counted the predetermined number of close requests or fewer, then the system 120 does not generate a close command and resets the timed interrupt.

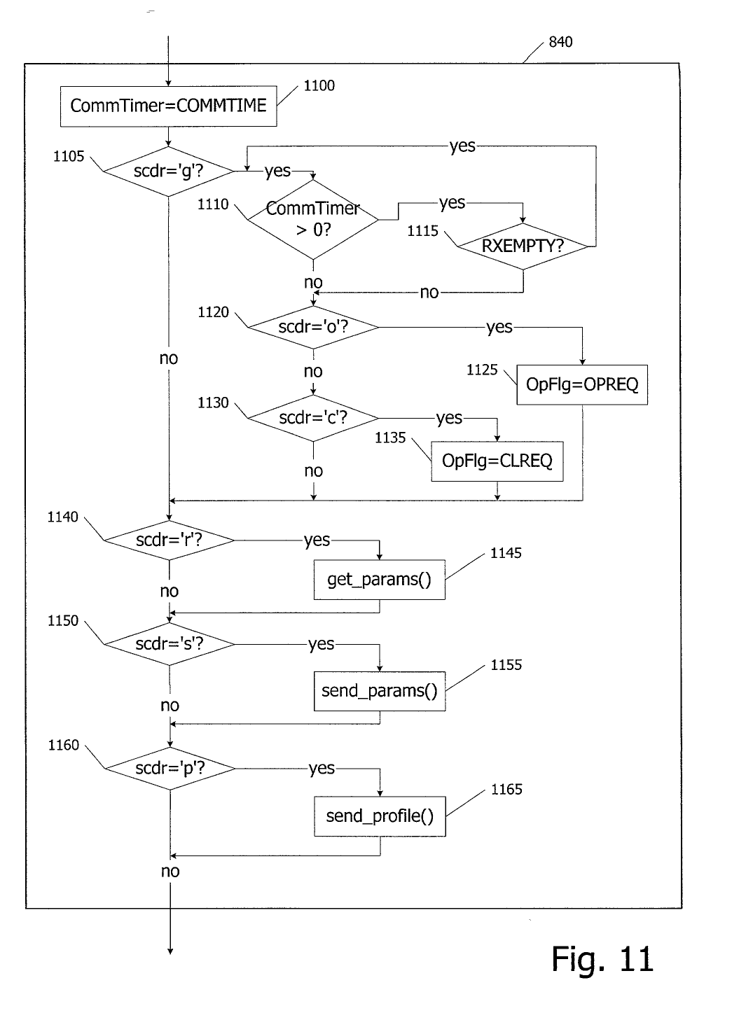

Referring also to FIG. 11, the system 120 performs a procedure 840 for interpreting the serial command and operating. The system 120 first sets a timer (called COMMTIME) that ensures that the serial command will be performed before the expiration of the timer (step 1100). The system 120 determines if the serial command is an operation command (for example, a ‘g’ command in ASCII text) (step 1105). If the serial command is an operation command and if the timer has not expired (step 1110), then the system 120 determines if the operation command is an open command by, for example, determining if the next character in an ASCII text is an ‘o’ (step 1120). If the operation command is an open command, then the system 120 sets an open operation command by, for example, setting an operation flag (OpFlg) to open (OPREQ) (step 1125). If the system determines that the operation command is a close command (step 1130), then the system 120 sets a close operation command by, for example, setting the operation flag to close (CLREQ) (step 1135).

If the serial command is an operation command and if the timer has expired (step 1110), then the system 120 determines if the serial command flag is empty (as indicated by flag RXEMPTY) (step 1115), which indicates that the serial command is not completed. If the serial command is not completed, then the system determines again if the timer has not expired (step 1110).

If the system 120 determines that the serial command is a check parameters command (for example, an ‘r’ command in ASCII text) (step 1140), then the system 120 obtains a list of parameters from the host computer (step 1145). If the system 120 determines that the serial command is a send parameters command (for example, an 's' command in ASCII text) (step 1150), then the system 120 sends a list of parameters to the host computer (step 1155). If the system 120 determines that the serial command is a send velocity information command (for example, a ‘p’ command in ASCII text) (step 1160), then the system 120 sends stored velocity profile information relating to the most recent operation to the host computer (step 1165). The stored velocity profile information may be a 64-byte signed character array.

If the system 120 does not receive a valid command, then the system resets the operation flags and simply exits.

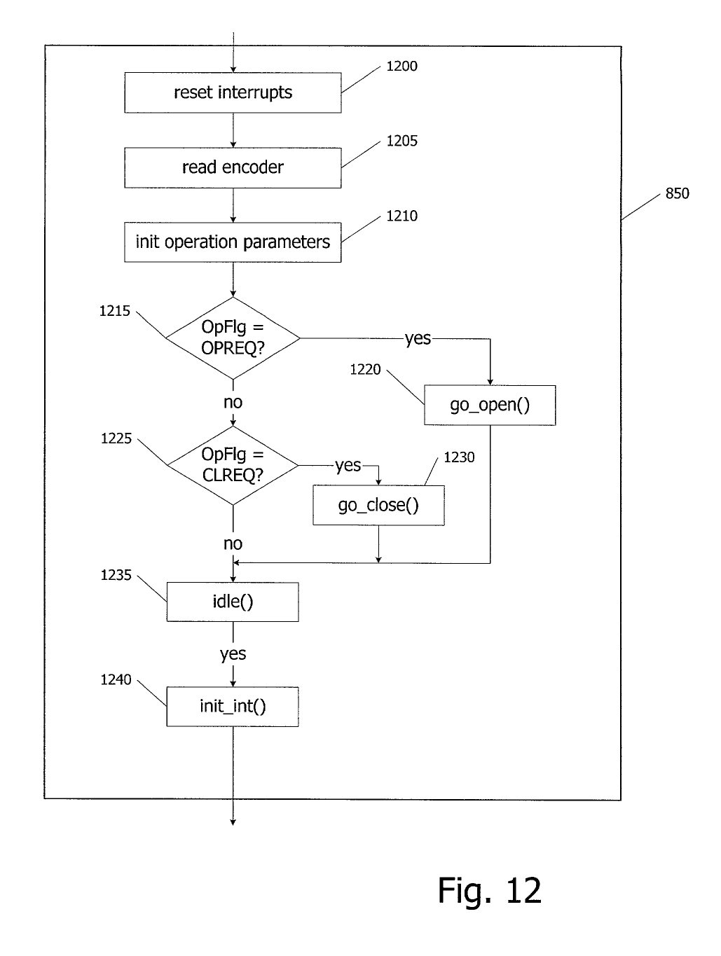

Referring also to FIG. 12, the system 120 performs a procedure 850 for executing an open or close operation. Initially, the system 120 resets the timer interrupt and disables any other interrupts (step 1200). Additionally, the system 120 reads the present velocity from the sensor 140 (step 1205) and saves the present velocity to a velocity profile array (step 1210).

The system 120 determines if an open operation command has been received as indicated by the operation flag being OPREQ (step 1215). If the open operation command has been received, then the system 120 executes the open operation (step 1220). The system determines if a close operation command has been received as indicated by the operation flag being CLREQ (step 1225). If the close operation command has been received, then the system 120 executes the close operation (step 1230).

The system 120 resets the actuator interface 150 to an off state and writes an internal register in the controller 160 if neither the close operation command nor the open operation command has been received, after the open operation has been executed, or after the close operation has been executed (step 1235). Then, the system 120 enables interrupts that are active (step 1240).

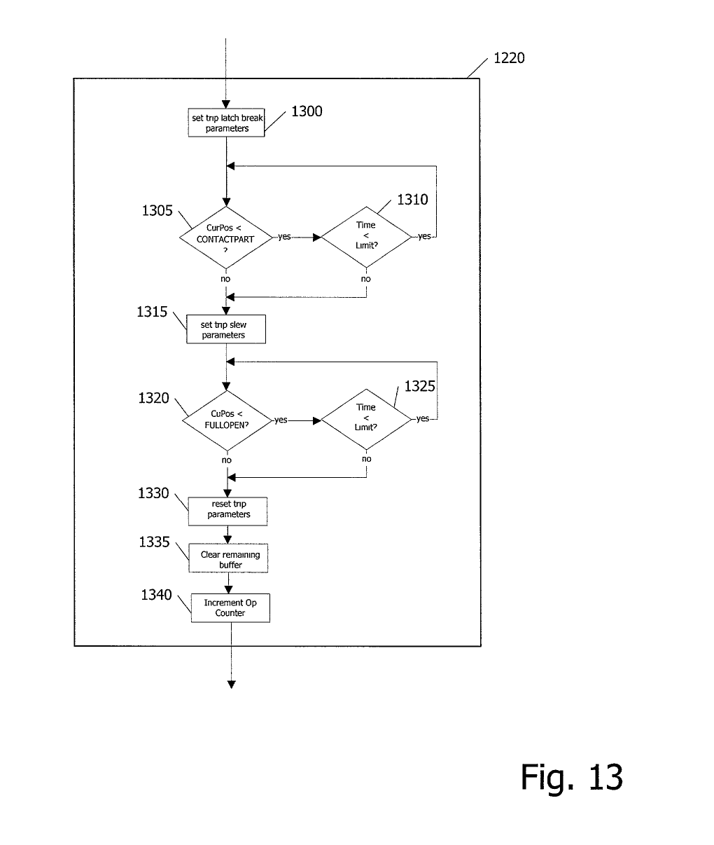

Referring also to FIG. 13, the system 120 performs a procedure 1220 for executing the open operation. Initially, the system 120 performs a sequence to break the force of the latching device that holds the contacts together. In this sequence, the system 120 outputs programmed parameters for breaking the force of the latching device in the interrupter 130 (step 1300). Thus, the system 120 outputs a predetermined current to the actuator 110 for a predetermined period of time. Next, the system 120 determines whether the position output from the sensor 140 is less than a predetermined position (called CONTACTPART) (step 1305). If the position is less than the predetermined position, the system 120 determines if the present time is less than the predetermined period of time (step 1310).

If the position output from the sensor 140 is greater than or equal to the predetermined position, or if the present time is greater than or equal to the predetermined period of time, then the system 120 performs a sequence to coast open the interrupter 130. During this sequence, the system 120 allows the actuator to coast unpowered until the interrupter 130 is in the final open position. Initially, the system 120 sets a flag that allows the timed interrupt to add current if the velocity drops below a predetermined level MINTRIPVEL (step 1315). Then, the system determines whether the position output from the sensor 140 is less than a predetermined open position (called FULLOPEN) (step 1320). If the position is less than the predetermined open position, the system 120 determines if the present time is less than a predetermined time (step 1325).

After the actuator 110 has reached a full open position (step 1320) or after the predetermined time has expired (step 1325), the system 120 resets trip parameters (step 1330) and continues to record velocities until a buffer that stores the velocity profile array is full (step 1335). This permits the system 120 to record any bouncing that might occur within the interrupter 130. The system increments an operation counter and disables the undervoltage shutdown in the backup supply 225 for a predetermined period of time until the system stabilizes (step 1340).

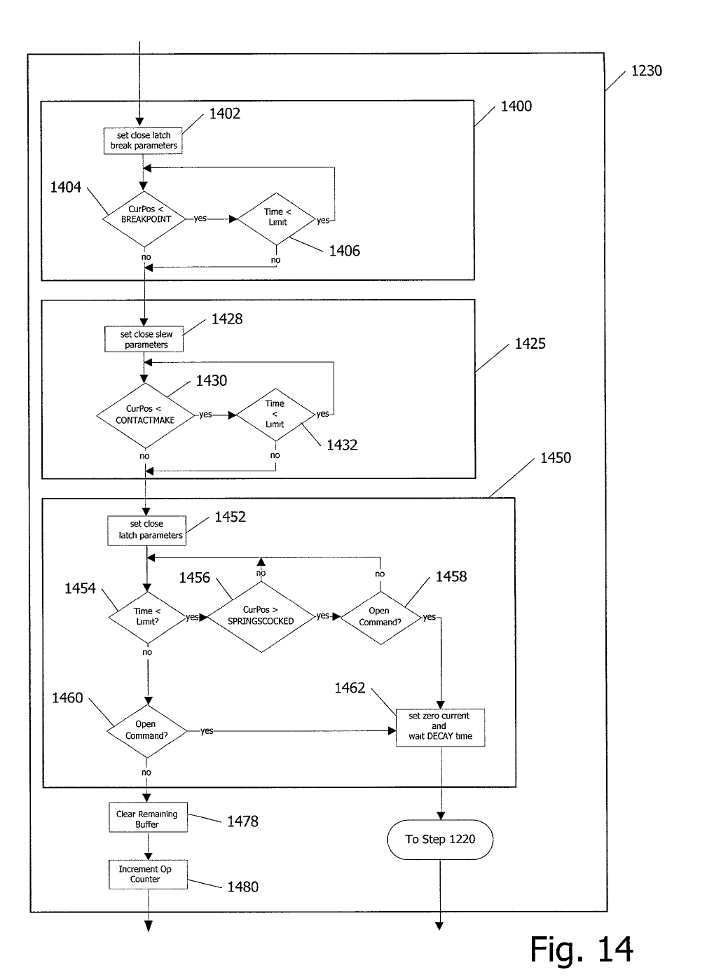

Referring also to FIG. 14, the system 120 performs a procedure 1230 for executing the close operation. Initially, the system 120 performs a latch break sequence to break the force of the latching device that retains the contacts in the open position (step 1400). Then, the system 120 performs a slew sequence that controls the velocity of the actuator 110 (step 1425). Lastly, the system 120 performs a latching operation sequence to retain the contacts in the close position (step 1450).

During the latch break sequence (step 1400), the system 120 outputs programmed parameters for breaking the force of the latching device in the interrupter 130 (step 1402). Thus, the system 120 operates the actuator 110 at a predetermined current for a predetermined period of time. Next, the system 120 determines whether the position output from the sensor 140 is less than a predetermined threshold position (called BREAKPOINT) (step 1404). If the position is less than a predetermined threshold position, the system 120 determines if the present time is less than the maximum time (step 1406).

If the position output from the sensor 140 is greater than or equal to the predetermined threshold position (step 1404) or if the present time is greater than or equal to the maximum time (step 1406), then the system 120 performs the slew sequence (step 1425). During the slew sequence, the system 120 attempts to control the velocity of the actuator 110 until a predetermined close position (called CONTACTMAKE) is reached. The system 120 outputs a current to the actuator 110 for a predetermined period of time (step 1428). Then, the system 120 determines whether the position output from the sensor 140 is less than the predetermined close position (step 1430). If the position is less than the predetermined close position, the system 120 determines if the present time is less than the predetermined period of time (step 1432).

After the actuator 110 has reached the predetermined close position (step 1430) or after the predetermined period of time has expired (step 1432), the system 120 enters the latching operation sequence (step 1450). During the latching operation sequence, the system 120 applies a predetermined current for a predetermined period of time (step 1452). While the time is less than the predetermined period of time (step 1454), the system 120 determines if the position of the actuator is greater than a latch position (called SPRINGCOCKED) (step 1456). If the position is greater than the latch position (step 1456), and if the time is less than the predetermined period of time (step 1452), then the system 120 checks for an open command (step 1458). Otherwise, if the time is not less than the predetermined period of time (step 1452), then the system 120 checks for an open command (step 1460). If an open command is received at either step, then the system 120 prepares the actuator (step 1462) and executes the open command using the procedure 1220 of FIG. 13.

If an open command is not received, then the system 120 continues to record velocities until a buffer that stores the velocity profile array is full (step 1478). This permits the system 120 to record any bouncing that might occur within the interrupter 130. The system increments an operation counter and disables the undervoltage shutdown in the backup supply 225 for a predetermined period of time until the system stabilizes (step 1480).

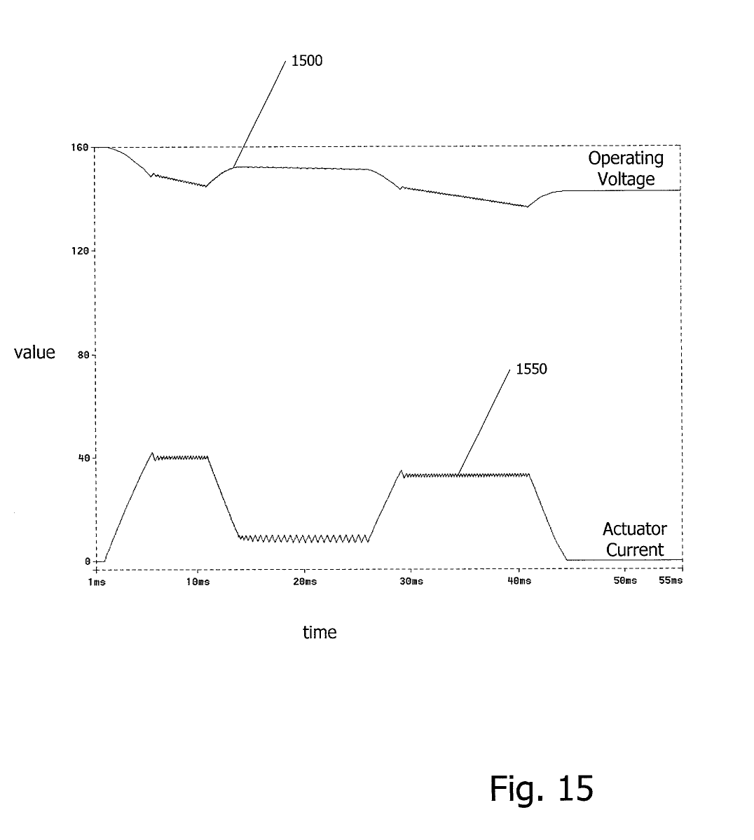

Referring to FIG. 15, a graph 1500 shows the operating voltage of the energy storage section 370 versus time and a graph 1550 shows the current through the actuator 110 versus time. This data was taken for a magnetic actuator. Thus, the current through the actuator 110 is the current through the coils of the actuator. As can be seen from these graphs, the current through the coils is independent of the operating voltage of the energy storage section 370. Moreover, because the energy storage section is operated at a higher than normal voltage, the time constants of the current rise are reduced. This makes it practical to precisely control the forces involved in opening and closing the interrupter 130. As can also be seen from graphs 1500 and 1550, the current through the coils is independent of the voltage produced by the actuator 110 during actuation.

Additionally, the controller 160 and the digital-to-analog converter 728 are used to produce a precise and repeatable current profile (as shown in graph 1550). The use of the controller 160 with the controllable actuator interface 150 provides practical motion feedback, which results in better control and energy savings.

A number of implementations have been described. Accordingly, other implementations are within the scope of the following claims.

What is claimed is:

1. A system for an AC electrical circuit, the system comprising:
an actuator that converts current into a force to move contacts relative to one another to switch power on and off in the AC electrical circuit;
a source that operates to supply current to the actuator; and
an actuator control system connected to the actuator and to the source to control the current to the actuator;
wherein the current to the actuator is independent of a voltage produced by the actuator during switching and a voltage at which the source operates.

2. The system of claim 1 further comprising an amplifier that controls the current from the source to the actuator.

3. The system of claim 2 further comprising a controller connected to the source and the amplifier, and configured to:
sense voltage from the source, and
provide information to the amplifier to control the current to the actuator.

4. The system of claim 1 in which the source operates at a voltage that is greater than the voltage produced by the actuator during switching.

5. The system of claim 1 in which the actuator converts the current into the force to move the contacts in a linear direction relative to one another.

6. The system of claim 1 in which the actuator switches power on and off in the AC electrical circuit by moving at least one of the contacts away from the other contact.

7. The system of claim 1 in which the contacts are connected to the AC electrical circuit such that when the contacts touch, current flows through the AC electrical circuit.

8. The system of claim 1 in which the actuator control system comprises a controller that senses the voltage provided by the voltage source.

9. The system of claim 1 further comprising control circuitry connected to the contacts; in which control of the actuator current is based on information from the control circuitry.

10. A method for controlling an actuator connected to an AC electrical circuit to interrupt current, the actuator being configured to convert current into a force to move contacts relative to one another to switch power on and off in the AC electrical circuit, the method comprising:
supplying power to an actuator; and
controlling current to the actuator such that the current to the actuator is independent of a voltage produced by the actuator during switching and a voltage at which the power is supplied.

11. The method of claim 10 further comprising:
sensing the voltage at which power is supplied to the actuator, and
providing information to control the current to the actuator.

12. The method of claim 10 in which the power is supplied at a voltage that is greater than the voltage produced by the actuator during switching.

13. The method of claim 10 in which the actuator switches power on and off in the AC electrical circuit by moving at least one of the contacts away from the other contact.

14. The method of claim 10 in which the contacts are connected to the AC electrical circuit such that when the contacts touch, current flows through the AC electrical circuit.

15. The method of claim 10 further comprising sensing the voltage at which power is supplied to the actuator.

16. The method of claim 10 in which control of the actuator current is based on information from the control circuitry.

17. The method of claim 10 in which the actuator converts the current into the force to move the contacts in a linear direction relative to one another.

18. An actuator control system for an AC electrical circuit, the actuator control system comprising:
an actuator interface that connects to an actuator that converts current into a force move contacts relative to one another to switch power on and off in the AC electrical circuit;
an input interface that connects to a source that operates to supply current to the actuator; and
a controller connected to the actuator interface and to the input interface to control the current to the actuator such that the current to the actuator is independent of a voltage produced by the actuator during switching and a voltage at which the source operates.

19. The system of claim 18 further comprising an amplifier that controls the current from the source to the actuator.

20. The system of claim 19 in which the controller is configured to:
sense voltage from the source, and
provide information to the amplifier to control the current to the actuator.

21. The system of claim 18 in which the source operates at a voltage that is greater than the voltage produced by the actuator during switching.

22. The system of claim 18 in which the actuator switches power on and off in the AC electrical circuit by moving at least one of the contacts away from the other contact.

23. The system of claim 18 in which the contacts are connected to the AC electrical circuit such that when the contacts touch, current flows through the AC electrical circuit.

24. The system of claim 18 in which the controller senses the voltage provided by the source.

25. The system of claim 18 in which the actuator control system is connected to control circuitry that is connected to the contacts; in which control of the actuator current is based on information from the control circuitry.
